(19) United States
(12) Patent Application Publication
(10) Pub. No.: US 2007/0071208 A1
(43) Pub. Date: Mar. 29, 2007

(54) System and a method for providing personalized electronic services and advertisements

(76) Inventor: Herb Morris, Oxnard, CA (US)

Correspondence Address: KELLEY DRYE & WARREN LLP, 400 ATLANTIC STREET, 13TH FLOOR, STAMFORD, CT, 06901, US

(21) Appl. No.: 11/489,053

(22) Filed: Jul. 19, 2006

Related U.S. Application Data
(60) Provisional application No. 60/703,586, filed on Jul. 29, 2005.

(51) Int. Cl. H04M 3/42

(52) U.S. Cl. 379/201.02

(57) ABSTRACT

A method and system are provided which allow a user to obtain electronic services and advertisements, including information and entertainment, all of which may be specific to the location or venue of a user. The system has a platform having an internet connection and a telephone connection and a user connection device communicatively connected to the platform via the internet connection and/or the telephone connection, wherein the user provides the platform with information via the user connection device in exchange for receiving electronic services. The system allows the user to accumulate points by providing information and/or playing games, the points being redeemable for free or discounted merchandise or services.

This application claims the benefit of priority of U.S. Provisional Application No. 60/703,586, entitled 's 7 A SYSTEM AND A METHOD FOR PROVIDING PERSONALIZED ELECTRONIC SERVICES AND ADVERTISEMENTS 's 8 , filed Jul. 29, 2005, which is incorporated by reference herein in its entirety.

### BACKGROUND OF THE INVENTION

Systems and methods for directing services and advertisements to a person or user based on the user 's purchasing or other habits are well known. For example, supermarkets have long hosted preferred shopper programs whereby a user has a preferred shopper card linked to an account. Upon checking out, the user swipes the preferred shopper card, allowing the supermarket to track the items bought by the user. In exchange for providing the supermarket with this information, the user receives various discounts on the items purchased. The supermarket uses this information to build a user profile, which is used primarily for marketing purposes. For instance, the supermarket shares this information with various vendors in exchange for coupons and other discounts, which are passed on to the user.

Some systems are mobile to allow for the user to benefit from targeted electronic services and advertisements over a larger geographic area. For example, U.S. Pat. No. 6,595,417 to O 's Hagan et al. ( 's 7 the O 's Hagan Patent 's 8 ) discloses a system for use in supermarkets. As with preferred shopper programs, the system disclosed by the O 's Hagan Patent builds a user profile based on the purchasing history of the user in order to provide the user with targeted advertising and other electronic services. Similarly, U.S. Pat. No. 6,259,405 to Stewart et al. ( 's 7 the Stewart Patent 's 8 ) discloses a system for use with rental cars that provides various electronic services, such as providing driving directions, as well as targeted advertising based on the user 's preferences.

One disadvantage with known systems such as those disclosed by the O 's Hagan and Stewart Patents is that the systems are accessible only in a particular venue. For example, the system disclosed by the O 's Hagan Patent is only accessible in a supermarket wired for such purposes. Similarly, the system disclosed by the Stewart Patent only is accessible in a private network wired for the proprietary service, such as properly equipped vehicles among the fleet of a particular car rental agency. As such, the only users who can benefit from the electronic services disclosed by the Stewart Patent are those members of the private system.

Accordingly, there is a need for a system and method for providing electronic services and advertisements that are accessible in multiple different venues or locations for maximizing the ability of the user to benefit from the various electronic services.

### SUMMARY OF THE INVENTION

In accordance with one aspect of the present invention, a system is provided for directing electronic services to a user. The system has a platform having an internet connection and a telephone connection and a user connection device communicatively connected to the platform via the internet connection and/or the telephone connection, wherein the user provides the platform with information via the user connection device in exchange for receiving electronic services. The system allows the user to accumulate points by providing information and/or playing games, the points being redeemable for free or discounted merchandise or services.

In accordance with another aspect of the present invention, a method is provided for obtaining electronic services by a user from a plurality of goods and services providers. The method includes the steps of logging on to a platform communicatively connected to the plurality of goods and services providers, providing information to the platform, accessing a first provider among the plurality of goods and services providers, and receiving electronic services from the first provider. By virtue of the method, the user accumulates points by providing information and/or playing games, the points being redeemable for free or discounted merchandise or services.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a diagram of the configuration of an embodiment of the present invention; and

FIG. 2 is a diagram of the configuration of another embodiment of the present invention.

### DETAILED DESCRIPTION OF THE INVENTION

The present invention is directed to a multimedia communications platform which includes data from a plurality of goods and services providers, or members, which form a provider community. The data includes electronic services, including information, e-commerce, entertainment, advertising, and product and service discounts, all of which may be specific to the location, venue and/or demographics of a provider community user. Users can access the platform at businesses subscribing to the platform services. Once connected to the platform, users may chose to provide the platform with information, purchase or obtain free of charge, information, games, or video clips, and/or purchase goods and/or services from provider community members. User habits and preferences are tracked by the platform provider which builds user profiles. Members of the provider community may have access to statistical data based on the user profiles and may use the statistical data to develop business marketing and sales plans. A provider may have to pay a fee to access the statistical data.

The provider community includes, but is not limited to, retailers, doctors, hotels, entertainment providers, banks, and real estate, insurance agencies, and car rental agencies. Retailers include, for example, supermarkets, mini-marts, restaurants, department stores, clothes stores, and gas stations as well as stores like Targets®, Wal-mart®, and K-Mart®. Furthermore, a provider community member may include a multiple location restaurant, store, bank, or the like. There is no limit to the type or number of goods and services providers that can comprises the provider community.

The provider community may comprise members that are located in limited geographic areas, such as a city, county, or state. Alternatively, the members of the provider community may be located in multiple states, throughout an entire country, and/or throughout multiple countries or continents.

In order to become a member of the provider community, providers may or may not have to pay a membership fee. If required, the membership fee may be a one time fee, an annual, fee, a semi-annual fee, or a monthly fee and may depend on the goods and services offered by the provider communities. As a member, the individual provider may be required to pay additional fees, such as platform connection fees, platform maintenance fees, and advertising fees.

In return, members of the provider community receive numerous benefits. For example, members have access to user profile data which contains information relating to a user 's buying habits and preferences. Such information can be useful to the member in developing marketing and sales plans. Additionally, members of the provider community also have the ability to place advertising in the electronic services provided by the platform. Advertising is intended to be of a passive nature for most of the electronic services offered by the platform, as described in more detail hereafter.

The platform may comprise a networked computer system that has at least one central processing unit (CPU) to process data. For purposes of increased reliability, the platform may have multiple CPUs to process data. Each CPU may have access to and process any portion of the data. Alternatively, the data is partitioned, and certain CPUs are assigned to specific portions of the data.

The platform also comprises at least one database to store the data. The data may be stored in a centralized database that is accessible by the CPU or all of the CPUs. For purposes of increased reliability, the data may be stored in multiple redundant databases, each being accessible by the CPU or all of the CPUs. Alternatively, the data is partitioned and specific portions of the data are stored in specific databases. In this configuration, the data may be accessible by the CPU or all of the CPUs. Alternatively, specific CPUs may be assigned to specific portions of the data.

The database or plurality of databases associated with the platform are used to store data related to both the users and members of the provider community. All of the data relating to the user, such as user profiles and account information, is stored in the database or plurality of databases associated with the platform. In addition, at least some of the data relating to provider community members is stored in the database or plurality of databases associated with the platform. For instance, at least some of the data relating to the products and/or services of a provider community member is stored in the platform databases.

Some data relating to provider community members also may be stored locally at the individual businesses. For instance, a restaurant that is a member of the provider community may store some data, such as its menu, on the platform databases. Other information, such as the purchasing history of a user at that restaurant, may be stored locally in a database maintained by the restaurant. The platform has the ability to determine what data is stored on the platform and what data is stored locally at the subscriber business.

The platform further may comprise at least one component to facilitate a telephone connection and at least one component to facilitate an internet connection between a subscriber business and the platform. For example, the platform may have a public branch exchange (PBX) server to facilitate a standard telephone (PSTN) connection. Alternatively, the platform may have a media server to facilitate a voice over internet protocol (VoIP) telephone connection. Additionally, the platform may have a web server to facilitate an internet connection between the platform and the provider community. Alternatively, the platform may have a media server to facilitate both telephone (PSTN and/or VoIP) and internet connections.

The platform also may include speech recognition engines and/or speech recognition software such that the platform can process automatic speech recognition (ASR) and interactive voice response (IVR).

The various components of the platform may be connected via a local area network (LAN) and/or a wide area network (WAN). Alternatively, the various components of the platform may be individually connected to the internet and have individual internet protocol (IP) addresses to facilitate intercommunication. The interconnection between the various components of the platform may be wireless, wire-lined, or a combination of both.

Subscriber businesses may be connected to the platform by at least one voice and data communications service provider via telephone (wireless or wire-lined), internet connections (wireless or wire-lined), and/or other suitable means known in the art. Subscriber businesses, in turn, allow individual users to connect to the platform. Communications service providers include, but are not limited to, communications companies such as, AT&T®, SBC®, Sprint®, Bellsouth®, Cingular®, Verizon®, Sprint®, or Vonage®. Some aspects of the platform information, such as certain portions of the user profiles, may be stored with the communications service providers. For instance, AT&T® may have a database server for storing some aspects of the platform locally.

Single location businesses, such as stores, restaurants, banks, shopping malls, and doctors 's offices may subscribe to the platform. Similarly, multiple location or “chain ” restaurants or stores may subscribe to the platform and provide their customers with access to the platform at all locations. As another example, all or some of the stores in a shopping mall (indoor or outdoor) may provide their customers with access to the platform.

Subscriber businesses then provide access to the platform to their customers. While at a subscriber business, a user may access the platform with his or her own user connection device or a device provided by the business. Businesses may or may not be required to pay a fee to subscribe to the platform. Whether a subscriber business must pay for access to the platform may depend on whether the subscriber business is also a provider community member. When a user first accesses the platform, the user will be asked to log in by providing an account number or, if the user does not have an existing account, the user will be asked if he or she wants to provide information for a more personalized experience. The user does not have to provide any additional information to use the platform services. However, the user may provide information to the platform at any time after the user session begins. Users will not be constantly asked to provide preferences.

Each subscriber business determines the type and amount of information that is available to the user at that particular business. For instance, the type and amount of information available to the user at a restaurant subscriber may be very different from the type and amount of information available to the user at a department store. As an example, a restaurant subscriber may choose to provide the user with information such as its menu, news, sports, and games while the user is frequenting that particular restaurant. A department store, on the other hand, may choose to provide the user only with information pertaining to the store and games but not news or sports. The type and amount of information available to the user at a particular business comprises a subset of the total data or information stored in the platform databases. Therefore, it is entirely possible that one business may choose to provide the user with a broad amount of information, while another business may choose to limit the scope of information to better tailor the information to the specific needs of the business. Alternatively, the platform provider may provide potential business subscribers with one or more “packages ” of information, services, and products which are keyed to that particular potential business subscriber.

The user connection device for inputting and receiving data intercommunicates with both the user and the platform. The user connection device includes those devices known in the art as well as any proprietary device directed to the specific networked computer system. For example, as previously discussed, the user connection device may be a cellular telephone, VoIP phone, or a landline phone. Additionally, the user connection device may be a tablet PC or a personal digital assistant (PDA), such as a BlackBerry® device manufactured by Research in Motion, Inc. or a Palm® device manufactured by Palm, Inc.

The user connection device also may be a personal computer having an internet connection (wireless or wire-lined). The computer includes any known computer device, including desktop and laptop computers for business and/or residential use. The internet connection includes any known connection, including dial-up service, a digital subscriber line (DSL), or internet connections provided by cable or satellite television providers.

Further still, the user connection device may be a television interface connected to the internet through a cable or satellite television connection. The television interface allows the user to access the platform through his or her television. The user interacts with the platform using on-screen menus, commands, or prompts.

Users of the provider community may or may not have a platform access account. However, individual users having an access account may receive benefits, which are not available to users without an account. In order to create an access account, a user provides the platform with the user 's name, address, gender, age, and/or other requested information. The user is then given an account identifier such as an account number which is used each time the user accesses his or her account. The user 's account also may be protected by a password or other personal identification number (PIN), depending upon the specific user connection device. For example, with a cellular telephone, the user account may be protected by a voiceprint, secret word, or utterance.

If a user has an account, the platform will build and save a user profile, which is based on the information provided to establish the account and the user 's activities. Each time a user accesses his or her account, the profile, including preferences and habits is updated. For example, if the user regularly purchases a specific brand of beverage, the system will add this preference to the user profile. User profiles are then used by the platform provider to provide the user with targeted electronic information, products, services, advertising and/or discounts. The specific information that a user is shown may vary depending on the user profile. For instance, a forty-five-year-old male user may be shown different information than a twenty-five-year-old male, and both may be shown different information than a twenty-five-year-old female, even if all of them are logging on to view similar news, sports, or the like. Additionally, the information may vary depending on the time and day in which the user views the information. For example, a user may be shown very different information on a Sunday afternoon than on a Friday night.

Users who do not have an account may still access the platform either through their own user connection device or the connection device provided by a subscriber business. A user without an account may or may not have access to the same goods or services offered by the provider community. User profiles, based on user data and preferences, can still be built for users without accounts However, these profiles will be much less detailed than those of users with accounts and will not be saved on the platform once the user logs off or disconnects from the platform. Each time the platform recognizes that a user does not have an account, the platform may ask the user if he or she would like to set up an account before the user is disconnected from the platform. The user is free to sign-up for an account at that time or ignore the request.

Regardless of whether a user has an account or not, the user 's preferences may be specific to the subscriber business. For instance, in a restaurant environment, the venue-based preferences may include, but are not limited to, eating habits, such as whether the user is a vegetarian or on a special diet, the user 's favorite dishes, how well the user prefers meat to be cooked, or the user 's favorite beer, wine, or carbonated beverage. In a department store environment, the venue-based preferences may include, but are not limited to, the types of clothing the user wears or the particular size of shirts, pants, or shoes. In a supermarket environment, the venue-based preferences may include, but are not limited to, the types or brands of items the user purchases or shopping habits, such as the time of day the user visits the supermarket. In a doctor 's office, the venue-based preferences may include, but are not limited to, the type of doctor the user is meeting or the general reason for the office visit. As another example, in a car rental environment, the venue-based preferences may include, but are not limited to, the type or brand of car the user selects, the user 's driving habits, and whether the user purchases or waives vehicle insurance. In a hotel environment, the venue-based preferences may include, but are not limited to, the type of activities the user enjoys, the user 's business needs, such as internet access, the user 's eating habits, such as whether the user orders room service or selects items from the room 's mini-bar, or whether the user takes advantage of concierge services, such as requesting laundry or dry cleaning to be performed. As yet another example, in a residential environment, the venue-based preferences may include, but are not limited to, the user 's domestic needs, the types of services the user purchases, and demographic information about the user 's living arrangements, such as whether the user rents or owns or whether the residence is an apartment, condo, or house. All of this information may be provided by a program specific to the subscriber business or venue.

The user provides this information to the platform through the user connection device using various commands. The commands depend upon the specific user connection device. For example, with a cell phone, the user interacts with the platform using touch tone (DTMF) commands. Alternatively, with cell phones, the user interacts with the platform using interactive voice response (IVR) or speech commands. As another example, with a PDA, tablet PC, or computer having an internet connection, the user may interact with the platform by completing and submitting internet (HTML-based) forms. Depending upon the capabilities of the specific user connection device, the user may interact with the platform using a combination of commands, such as, DTMF and speech commands.

Based on the user 's habits and/or preferences, the platform provider offers the user various electronic services that are chosen from the set of services selected by the subscriber venue. The electronic services include, but are not limited to, information, entertainment, advertising, and the sale of goods and services. Information includes, but is not limited to, for example, news, weather, or sports. Information may be location or venue-specific, such as providing information about a particular restaurant, store, or doctor 's office. For instance, platform may provide the user with the menu of a restaurant. The information also may be of a more general nature, such as national or world news, weather, or sports updates.

Entertainment includes, but is not limited to, games, electronic books (e-books), music, or streaming media for all ages as well as child or adult-specific. For instance, a member of the provider community may provide the user with free games or games for purchase. Games include both educational games, such as trivia games, as well as games of amusement, such as video games. As another example, the system may provide the user with video clips, such as movies or music videos. As yet another example, a user may be able to download an electronic book (e-book) for display on the user connection device. The platform also may provide the user with internet access and the ability to view internet web pages and web sites.

The advertising for goods and services of provider community members generally is location or venue specific. For instance, a user who routinely purchases a type of carbonated beverage may be presented with advertisements for this type of beverage while dining at a restaurant. The platform provider chooses advertisements based on the user profile and the user 's preferences. The advertisers and/or the business subscribers do not have control over the display of advertisements.

Advertising is intended to be of a more passive nature for most of the electronic services. At no time will the user be required to view an advertisement before accessing platform services, information, or products. For example, when the user is accessing news, sports, or any of the general information selected by the business subscriber, the user will not be presented with any advertising. However, if the user requests specific information outside of what has been selected by the business subscriber, then the user may be provided with advertisements. For example, if the user is viewing financial news on the platform and then requests additional information on mortgage interest rates, the user may be shown ads relating to mortgage lenders.

Advertisements may be of a more passive nature, such as banner advertisements placed at the top or side of the display screen. Alternatively, advertisements may be embedded into the electronic services. For example, in a football video game, advertisements may be placed on the players ' uniforms or on the scoreboard or elsewhere in the stadium. As another example, advertisements for carbonated beverages or brands of foods may be embedded into the menu of a restaurant business subscriber. Advertisements also may be in the form of a commercial, whereby the user watches or listens to the advertisements.

In exchange for providing the platform with data and user preferences, the user receives certain benefits, such as points or coupons. For example, the user may accumulate points for purchasing services or products or for playing games.

Based on the configuration of the platform, a user with an account can accrue points through interaction with the platform. The platform provider is responsible for determining the number of points earned, storing a record of the user 's points, and otherwise managing a user 's accrued points. User 's without accounts may also accrue points and then be required to obtain an account in order to redeem the accrued points. For example, where the provider community is accessible through a chain of restaurants, a user having an account can accrue points by interacting with the provider community at any one of the chain locations. The user may accumulate points at a restaurant in the chain, by answering certain questions, playing games, purchasing various products or services, or consuming certain foods or drinks.

The points may be redeemed for free or discounted merchandise or services from any one of the members of the provider community. For instance, where the platform is accessible at a chain of fast-food restaurants, earned points may be redeemed for free or discounted fast-food. Alternatively, the points may be redeemed for free or discounted products or services from one of the other members of the provider community.

For example, while waiting for a table at a restaurant, a user may decide to play a video game. Points accrued during the playing of the video game may be redeemed for free or discounted merchandise or services from any of the provider community members. For instance, while a user may earn points by playing a video game while waiting for a table at a restaurant, the points can be redeemed for a discounted stay at a hotel.

The present invention may be used in connection with many specific applications. Examples of several contemplated embodiments are set forth below. The subject matter of this disclosure may, however, be embodied in many different forms and should not be construed as being limited to the aspects or embodiments set forth herein. Each example set forth below contemplates that the user may access the platform by using his or her own personal user connection device or a user connection device provided by subscriber business.

Restaurants

In one embodiment of the present invention, a customer enters a restaurant which is a subscriber to the platform. The customer cannot be seated immediately and puts his name on the waiting list. The restaurant then provides the customer with a PDA, a tablet PC, or a proprietary user connection device to access the provider community while the customer waits. The user device provided by the restaurant also may serve as a pager to alert the user that his or her table is ready. For example, the user connection device may alert display an on-screen message when a table is available. Alternatively, the user connection device may alert the user of an available table through visual means, such as a flashing light, as well as through audible means, such as a noise or message, or through physical means, such as vibrations, or any combination of such alerts.

A user having an existing account with the platform may sign onto the account while at the restaurant using his or her own user connection device or a user device provided by the restaurant. In this manner, the user 's activity is monitored by the platform, and any points accumulated through the user 's activity will be tracked by the platform and saved to the user 's account.

Users not having existing accounts with the platform are still able to interact with user devices provided by the restaurant. In this manner, the user may begin interacting with the user device, such as by playing a video game while waiting for a table. The user device may ask the user if he or she would like for the experience to be personalized. If the user chooses to have a personalized experience, the user may answer a few questions such that a temporary profile can be generated to better target the electronic services to the user. The temporary profile lasts as long as the user desires to interact with the user device. At the end of the user 's session, the user device may ask the user if he or she would like to sign up for a permanent account with the platform, in which case the user may log onto the platform at a future time and benefit from the points accrued while interacting with the user device at the restaurant.

Alternatively, the user may not choose to have a personalized experience. In this case, a default profile is enabled, whereby the user is logged on as a guest. In the guest mode, the user is provided with a default set of electronic services that are not necessarily targeted to any one user.

While waiting for his or her table, the customer may access a table of contents on the user connection device which is used to navigate through the goods and services on the platform that are offered by the restaurant. The table of contents may include several icons or tabs for accessing the restaurant menu, restaurant recipes, news, entertainment, and/or weather. The user may navigate through the platform by any of the methods discussed above depending on the type of user connection device provided by the restaurant. For example, if the customer is provided a small tablet PC, the customer may navigate through the table of contents using a touch screen feature or using an integrated trackball mouse device.

Initially, the customer may select the menu icon. When viewing the menu, the customer may be shown one or more advertisements from the restaurant or the members of the provider community. The advertisements may be based on the user 's location at the restaurant or in response to information or preferences provided by the user. Alternatively, the restaurant may initially provide the same information to each user regardless of user preferences.

If the customer has a child at the restaurant, the customer may next select the entertainment icon. Prior to being provided with the types of entertainment available from the provider community, the customer or his or her children may want to provide information to the platform. For example, the user may want to provide responses to the following questions: Are you interested in entertainment for adults or children? If interested in entertainment for a child, what is the age and sex of the child? What is the child 's favorite soft drink? Does the child prefer video games or music? Based on the responses to these questions, the customer and/or child will be provided with a list of free games that can be played, and/or a list of songs that can be played on the payment of a fee.

If the customer has a platform user account, the customer will accrue points for allowing his or her child to play a game. The customer may accrue a higher number of points by choosing to an entertainment option that requires some type of monetary payment. Depending on the number of points accrued while the customer is waiting for his or her table, the customer may be provided with a discount on food or beverages consumed on that visit or the customer 's next visit to the restaurant.

As previously discussed, the user device may light-up and/or blink to alert the customer that his or her table is ready. Once the customer is notified that his or her table is ready, the customer goes back to the host/hostess stand and returns the user device to the host or hostess. The customer is then seated at a table. When seated, the customer may find another user device at the table which provides access to the same information, products and services that were available on the user device/pager. The customer can continue listening to music or playing a game previously purchased while waiting for a table, or the customer can choose to view new information, products, and/or services while waiting for his or her food. Alternatively, the user may be provided with a single user device that is used to alert the user when the table is ready and also may be brought to the table for continued use and enjoyment. The user device may be configured such that the user can pay his or her bill using the device, such as by entering a credit card number.

Retailing Shopping

In another embodiment of the invention, a user enters a home improvement store, which is a member of a provider community. Upon entering the store, the user is informed that the store subscribes to the platform. Subsequently, the user pulls out his or her PDA, logs into the platform, and is directed to services offered by the store on the platform. While logged into the platform, the user is able to obtain specific locations for desired items and/or assistance in determining all of the necessary items for completion of a home improvement project. For example, a user wanting to build a deck is provided with the specific locations of and recommendations for wood screws, lumber, stain, and other components critical to completion of the deck project. In exchange for these services, the user may be shown advertisements while he is walking through aisles and collecting the needed items for his project. The advertisements from members of the provider community may be chosen in response to various criteria, including but not limited to, the type of project the user is working on or in response to the location of the home improvement store. Alternatively, the user may provide the home improvement store with answers to questions, which may used to further build the user profile. Again, if the user has a platform account, the user 's profile will be updated based on the information supplied while at the store and/or the products and services purchased from the store. This particular embodiment of the present invention also may be used in other retail environments, such as department stores and supermarkets.

Doctors ' Offices

Similar to the embodiment of the present invention previously discussed relating to restaurants, a patient may be provided a user connection device which also functions as a pager when arriving for an appointment. As with the restaurant venues, the user connection device provides the user with information such as the news, services such as internet access, and/or entertainment such as video games. However, instead of providing information such as the menu for the restaurant and recipes, medical information may be available to the patient. For example, if the patient is waiting to see an orthopedic surgeon for knee problems, the user may choose to view information relating to knee surgery procedures. If the patient has a platform account, the manufacturer of the knee braces may email the patient a discount coupon for a knee brace. Depending on the reasons for seeing the doctor, the staff at the doctor 's office may be able to “program ” the user device to show the patient specific information. For example, if the patient is seeing the doctor for the last time before having surgery, the user may be required to view pre-surgery preparation instructions and post surgery tips before being able to access any other content on the platform.

When the doctor is ready to see the patient, the user connection device may alert the patient by numerous methods, including, but not limited to, displaying an on-screen message, activating flashing lights, making a noise, and/or vibrating.

Hotel Concierge Services

In still another embodiment of the invention, a user interacts with a provider community while staying at a hotel. The user may access the platform through his or her own PDA, notebook computer, cellular telephone, or through a television interface or telephone in the user 's hotel room. Once the user accesses the platform, the user may obtain information relating to the hotel facilities, hotel services, recreational activities, or information relating to the surrounding area, attractions, and restaurants. The hotel may also provide services, such as concierge services, internet access, checkout services and entertainment services, including but not limited to, movies, video games, and music through the provider community.

When requesting information relating to area restaurants, the hotel guest may be shown listings for various restaurants. If the hotel guest chooses one of the listed restaurants and makes reservations through the platform, the hotel guest may be given a discount on the cost of his meal. Alternatively, the hotel guest may receive a discount from the restaurant by indicating that he chose the restaurant based on seeing the restaurant listings while using the platform.

Rental Cars

In a further embodiment of the invention, a user interacts with the platform while traveling in a rental car. For safety reasons, the user connection device is a device mounted or displayed on the dashboard of the car and responds to the voice commands of the user. When logged into the platform, the user is provided with information about the surrounding area, such as the location of gas stations, hotels, and restaurants. Additionally, the user may be provided with services, such as directions and roadside assistance. The user may also have access to entertainment services such as music and e-books. In order to personalize these electronic services, the user may provide the platform with various information or preferences, all of which are used by the platform provider to further build the user profile.

Home Use

In still a further embodiment of the invention, the user interacts with the platform at home. Similar to the above aspect relating to hotel venues, the system is accessed by the user either through a portable user connection device, such as a PDA or tablet PC, or through a television interface. Once logged into the platform, the user is provided with certain information, such as information about the surrounding area and attractions. The platform also provides the user with domestic services, such shopping on the internet. Additionally, the platform provides the user with access to provider community members who offer entertainment, including video games or movies. In exchange for these electronic services, the user provides the platform provider with certain information or preferences, all of which are used by the platform provider to further build the user profile. For instance, the user may be asked questions pertaining to the user 's home or living arrangements in order to access the electronic services. Additionally, the user may watch or listen to various advertisements, which may be location or venue-specific.

Gaming On Hold

In another embodiment of the invention, the user interacts with the platform while waiting in a hold queue of a phone system. For instance, a user placed on hold while trying to contact, for example, a utility company is provided with entertainment such as a game. The user plays the game while his or her phone call remains in queue. Upon connection with a customer service representative, the platform provider gives the user a toll-free phone number upon which the user may resume the game. Upon calling the toll-free number, the user may be asked various questions before the user can resume the game. Alternatively, the user pays a fee to play the various games and is not asked questions by the platform or does not have to listen to sponsored advertisements. As yet another alternative, the user is provided with information, such as news, weather or sports, or other types of entertainment, such as music. For example, a user placed on hold while trying to contact, for example, a bank is provided with local news. In order to continue listening to the news, the platform provider asks the user a question pertaining to the nature of the user 's phone call. Upon answering the question, the user is provided local news or other information.

Description of the Figures

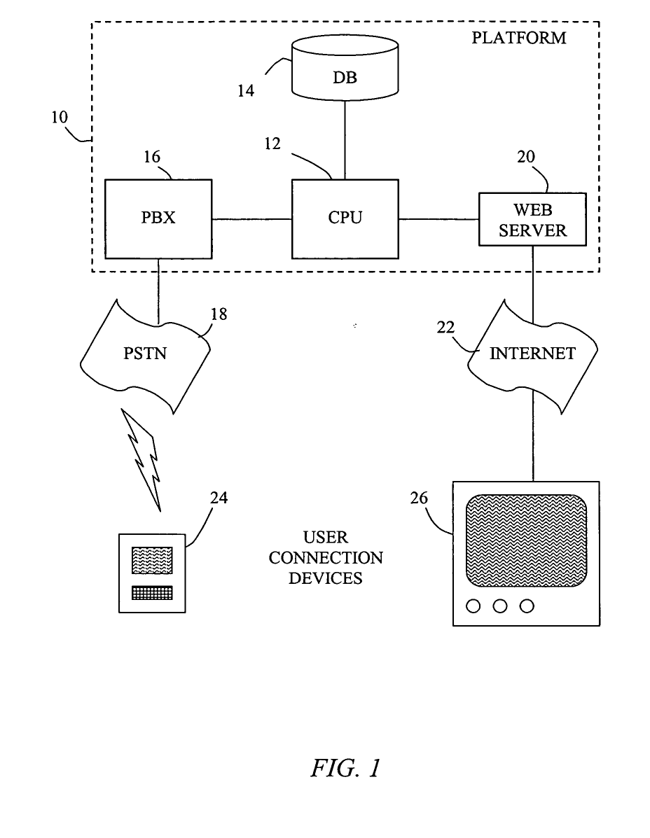

Referring now to the drawings, wherein like reference numerals designate identical or corresponding parts throughout the several views, FIG. 1 is a diagram of one configuration of the present invention. As shown in FIG. 1, the platform 10 includes a CPU 12 operatively connected to a database 14, which stores the data relating to both the user and the subscriber businesses. The platform 10 further includes a phone connection, such as PBX 16, which is communicatively connected to PSTN 18. Still further, the platform 10 includes a web server 20 communicatively connected to the Internet 22. In this configuration, the user connection devices 24, which include landline and cell phones, PDA devices, and tablet PCs are capable of communicating with the platform 10 via a standard telephone line 18. Additionally, user connection devices 26, which include VoIP phones, personal computers having internet connections, and TV interfaces are capable of communicating with the platform 10 via the Internet 22.

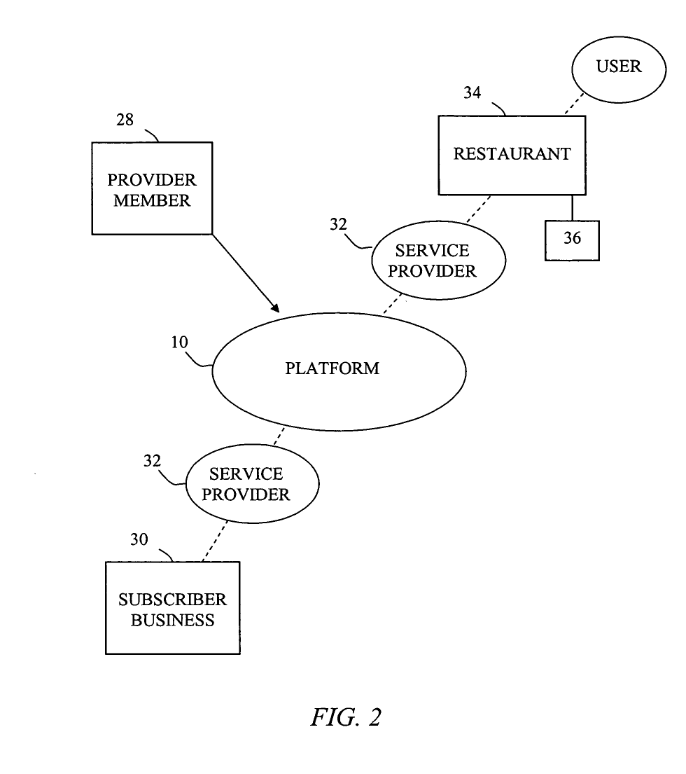

FIG. 2 is a diagram of another configuration of the present invention whereby platform 10 is communicatively connected to various members and subscribers of the provider community. As shown in FIG. 2, a provider community member 28 provides the platform 10 with data relating to the user. Additionally, subscriber businesses 30, such as restaurants, department stores, doctors ' offices, hotels, and car rental agencies, are communicatively connected to the platform 10 to allow a two-way exchange of information. Subscriber businesses 30 are connected to the platform 10 via telephone and/or internet service providers 30, such as AT&T®, SBC®, Sprint®, Bellsouth®, Cingular®, Verizon®, Sprint®, or Vonage®. For example, a subscriber business, such as restaurant 34, may be connected to the platform 10 via an internet service provider 30. Further, the restaurant 34 may have a local database 36 as part of its own networked computer system. A user arriving at the restaurant may choose to interact with the platform 10 while waiting for a table, as described above. Data relating to the user is stored on the platform 10; however, some data relating to the user may be stored in the local database 36 at the restaurant 34.

Many changes and modifications will occur to those skilled in the art upon studying this description. All such changes and modifications which are within the spirit of the invention are intended to be included within the scope of the claims.

We claim:

1. A system for providing electronic services to a user comprising:
a platform having an internet connection and a telephone connection; and
a user connection device communicatively connected to the platform via the internet connection and/or the telephone connection, wherein the user provides the platform with information via the user connection device in exchange for receiving electronic services.

2. The system of claim 1 wherein the electronic services are location or venue-specific.

3. The system of claim 1 wherein the information provided by the user is selected from the group consisting of name, age, gender, and personal preferences.

4. The system of claim 3 wherein the personal preferences are location or venue-specific.

5. The system of claim 1 wherein the electronic services are selected from the group consisting of information and entertainment.

6. The system of claim 5 wherein the information is selected from the group consisting of news, sports, weather.

7. The system of claim 5 wherein the entertainment is selected from the group consisting of the internet, video games, electronic books, music, video clips, and streaming media.

8. The system of claim 1 wherein the user connection device is selected from the group consisting of cell phones, landline phones, voice over internet protocol phones, personal digital assistants, tablet personal computers, personal computers, laptop computers, and television interfaces.

9. The system of claim 1 wherein the user accumulates points for providing information, said points being redeemable for free or discounted merchandise or services.

10. The system of claim 1 wherein the user accumulates points for playing games, said points being redeemable for free or discounted merchandise or services.

11. A system for providing electronic services to a user comprising:
a platform having a telephone connection; and
a user connection device communicatively connected to the platform via the telephone connection, wherein the user calls into the platform with the user connection device and provides information in exchange for receiving electronic services.

12. The system of claim 11 wherein the user receives the electronic services after being placed in a telephone holding queue.

13. The system of claim 12 wherein the user saves progress of the electronic services for later enjoyment.

14. The system of claim 13 wherein the user resumes progress of the electronic services by calling back into the platform.

15. The system of claim 11 wherein the information provided by the user is selected from the group consisting of name, age, gender, and personal preferences.

16. The system of claim 11 wherein the electronic services are selected from the group consisting of information and entertainment.

17. The system of claim 16 wherein the information is selected from the group consisting of news, sports, weather.

18. The system of claim 16 wherein the entertainment is selected from the group consisting of games, music, and streaming media.

19. The system of claim 11 wherein the user connection device is selected from the group consisting of cell phones, landline phones, and voice over internet protocol phones.

20. The system of claim 11 wherein the user accumulates points for providing information, said points being redeemable for free or discounted merchandise or services.

21. The system of claim 11 wherein the user accumulates points for playing games, said points being redeemable for free or discounted merchandise or services.

22. A method of obtaining electronic services by a user from a plurality of goods and services providers comprising the steps of:
logging on to a platform communicatively connected to the plurality of goods and services providers;
providing information to the platform;
accessing a first provider among the plurality of goods and services providers; and
receiving electronic services from the first provider.

23. The method of claim 22 further comprising the step of accumulating points for providing information, said points being redeemable for free or discounted merchandise or services.

24. The method of claim 22 further comprising the step of accumulating points for playing games, said points being redeemable for free or discounted merchandise or services.

25. The method of claim 22 wherein the electronic services are location or venue-specific.

26. The method of claim 22 wherein the information provided by the user is selected from the group consisting of name, age, gender, and personal preferences.

27. The method of claim 26 wherein the personal preferences are location or venue-specific.

28. The method of claim 22 wherein the electronic services are selected from the group consisting of information and entertainment.

29. The method of claim 28 wherein the information is selected from the group consisting of news, sports, weather.

30. The method of claim 28 wherein the entertainment is selected from the group consisting of the internet, video games, electronic books, music, video clips, and streaming media.

31. The method of claim 28 wherein the user connection device is selected from the group consisting of cell phones, landline phones, Voice over internet protocol phones, personal digital assistants, tablet personal computers, personal computers, laptop computers, and television interfaces.

32. A system for providing electronic services to a user comprising:
a platform having an internet connection and a telephone connection; and
a user connection device communicatively connected to the platform via the internet connection and/or the telephone connection, wherein the user receives electronic services via the user connection device and is not required to provide the platform with information.

33. A method of obtaining electronic services by a user from a plurality of goods and services providers comprising the steps of:
logging on to a platform communicatively connected to the plurality of goods and services providers;
accessing a first provider among the plurality of goods and services providers; and
receiving electronic services from the first provider.
